(19) United States
(12) Patent Application Publication
(10) Pub. No.: US 2015/0350067 A1
(43) Pub. Date: Dec. 3, 2015

(54) SYSTEM AND METHOD OF MINIMIZING PACKET LOSS DURING REDUNDANT PAIR SWITCHOVER

(71) Applicants: AMIT GOYAL, Fremont, CA (US); ABDUL RAHIM PALAKKATTU KAREEM, Sunnyvale, CA (US); VACHASPATHI PETER KOMPELLA, Cupertino, CA (US)

(72) Inventors: AMIT GOYAL, Fremont, CA (US); ABDUL RAHIM PALAKKATTU KAREEM, Sunnyvale, CA (US); VACHASPATHI PETER KOMPELLA, Cupertino, CA (US)

(73) Assignee: ALCATEL-LUCENT USA INC., MURRAY HILL, NJ (US)

(21) Appl. No.: 14/502,743

(22) Filed: Sep. 30, 2014

Related U.S. Application Data
(60) Provisional application No. 62/005,506, filed on May 30, 2014.

(51) Int. Cl. H04L 12/741

(52) U.S. Cl. CPC H04L 45/54

(57) ABSTRACT

Systems, methods, architectures, mechanisms and/or apparatus to manage routing associated with a redundant pair of nodes during a switchover from an old active node to a new active node by establishing a tunnel there between to convey traffic routed to the old active node prior to routing protocol convergence at the new active node.

### CROSS-REFERENCE TO RELATED APPLICATION

This application claims the benefit of U.S. Provisional Patent Application Ser. No. 62/005,506, filed on May 30, 2014, entitled SYSTEM AND METHOD OF MINIMIZING PACKET LOSS DURING REDUNDANT PAIR SWITCHOVER, which application is incorporated herein by reference.

### FIELD OF THE INVENTION

The invention relates to the field of network management and, more particularly but not exclusively, to management of traffic switchover between redundant pairs of nodes in a network.

### BACKGROUND

Inter-Chassis Redundancy (or Geo-Redundancy) is a widely used network deployment model in Mobile networks for providing fault tolerant service to end users. Two redundant nodes are provided in this model, one operating as an active Gateway or active node, and one acting as a standby Gateway or standby node. The standby node is used as a backup to the active node in case the active node fails or goes off-line for some reason, such as during a scheduled maintenance or other planned activity in the network (e.g., software upgrade, hardware upgrade/repair and the like).

Typically, during a scheduled maintenance of an active node, an operator triggers a switchover of service responsibilities from the active node to the standby node, and the deployed routing protocol mechanism is used for re-routing traffic from the old active node to the new active node (i.e., to the former standby node). This change in routing is subject to the route convergence delay inherent to the network. If Border Gateway Protocol (BGP) is used as the routing protocol, then routing convergence delays are of the order of 30 seconds or more. During this routing convergence delay time, those packets already propagated toward the former active node are typically lost/dropped. Lost time due to packet retransmission, route reconvergence and so on results in service interruptions approaching 50 seconds or more in duration.

A 50+ second service interruption penalty, while significant, has been tolerated by service providers for many years as a normal penalty to pay at the time of periodic maintenance of Service Gateway (SGW), Packet Gateway (PGW) and/or other nodes within a service provider network.

### SUMMARY

Various deficiencies in the prior art are addressed by systems, methods, architectures, mechanisms and/or apparatus to manage routing associated with a redundant pair of nodes during a switchover from an old active node to a new active node by establishing a tunnel there between to convey traffic routed to the old active node prior to routing protocol convergence at the new active node.

One embodiment comprises a method for reducing traffic loss during redundant pair switchover from an old active node to a new active node, the method includes establishing a tunnel between the old active node and the new active node; and updating routing tables to cause intermediate node preference for the new active node; wherein packets routed toward the old active node prior to routing protocol convergence to the new active node are routed to the new active node via the established tunnel.

### BRIEF DESCRIPTION OF THE DRAWING

The teachings herein can be readily understood by considering the following detailed description in conjunction with the accompanying drawings, in which:

FIG. 1 graphically depicts a network benefiting from various embodiments;

FIG. 2 depicts the network of FIG. 1 including a graphical representation of traffic routing in accordance with at least one embodiment;

FIG. 3 depicts a flow diagram of methods according to various embodiments; and

FIG. 4 depicts a high-level block diagram of a computing device suitable for use in performing the functions described herein.

To facilitate understanding, identical reference numerals have been used, where possible, to designate identical elements that are common to the figures.

### DETAILED DESCRIPTION OF THE INVENTION

Various embodiments contemplate a mechanism to minimize packet loss during the scheduled force switch-over of service responsibilities from an active node to a standby node, such as within the context of a geo-redundant pair of nodes. The mechanism decouples packet loss from route convergence in network by establishing a path between active node and standby Node for forwarding to the standby Node those packets in transit toward the active node prior to the switchover. In this manner, packet loss is reduced by many seconds and, importantly, the specific impact of the switchover becomes deterministic rather than dependent upon the network topology.

As soon as a switchover is determined, the routes are updated such that traffic continues to be received on either one of the nodes, instead of getting black holed at an intermediate node. After the switchover completes, tunneled packets received by old Active node are still forwarded to the new Active node. This can occur for a relatively short period of time as the traffic flushes out of this path (no new traffic added to this path).

Thus, given the enormous number of mobile services supported by service provider nodes subject to scheduled or periodic maintenance, the various embodiments advantageously provide sustained quality services to subscribers and customers where such services might otherwise be disrupted as discussed herein. The various embodiments operate to minimize the service impact of transitioning service responsibilities from an active node to a standby node, and find particular utility within the context of scheduled maintenance or other predictable situations necessitating such a transition.

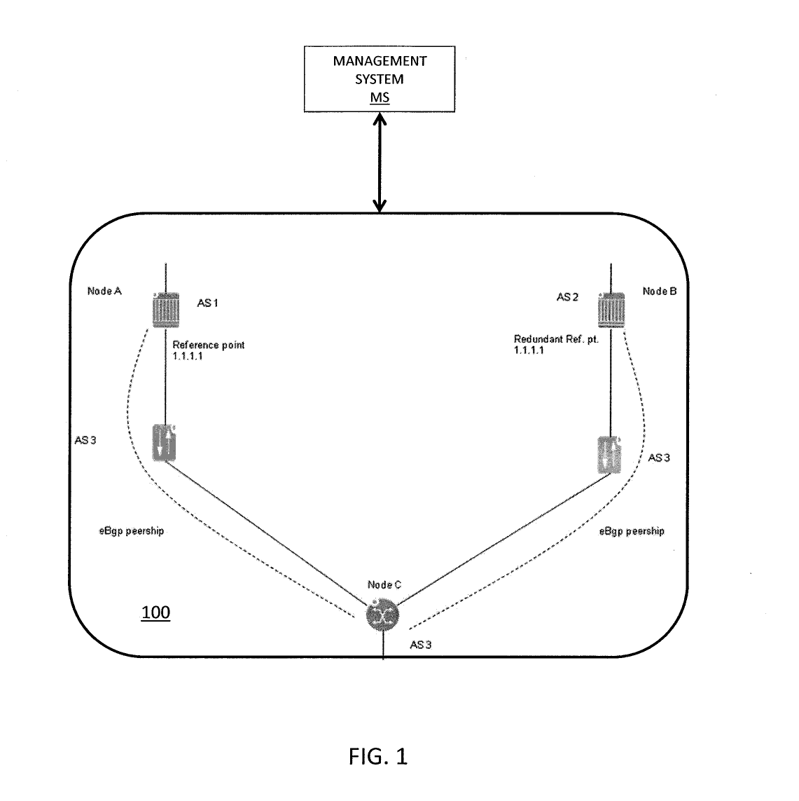

FIG. 1 depicts a high-level block diagram of a network benefiting from the various embodiments. Specifically, FIG. 1 depicts a portion of a network wherein a first network element denoted as Node A and a second network element denoted as Node B form a redundant pair of nodes, wherein each Node is associated with the same IP address (illustratively, 1.1.1.1). A network element denoted as Node C routes traffic toward Node A or Node B in accordance with routing information determined via, illustratively, Border Gateway Protocol (BGP) though other routing protocols may also be employed within the context of the various embodiments. The three nodes are depicted as having different Autonomous System (AS) numbers. As such, the three nodes are in an external BGP (eBGP) session. Various embodiments contemplate the use of other types of relationships, protocols and the like for implementing intermediate and destination Node sessions, routing information exchange and the like.

In steady state, Node A is acting as an Active Gateway or node, and Node B is acting as a Standby Gateway or node. In this case intermediate Node C will route all traffic to A. That is, Node C would prefer a route towards A over a route towards B for a particular destination prefix (e.g., 1.1.1.1) based on some criteria, such as cost.

When the switchover from Node A to Node B is to occur, Node C must update it routing tables to route traffic towards B. The more time Node C requires to update its routing tables and provide convergence, the greater the potential traffic loss during the switchover. The various embodiments operate to resolve the packet loss issue during switchover activity by updating the routing tables of Node C such that packets do not get “black holed” (lost or discarded) at Node C, but instead are propagated by Node C toward Node A until such time as the route to Node B becomes the preferred packet forwarding route in Node C's routing table.

Specifically, after switchover Node A has transitioned to non-active state and therefore cannot process/forward the packets meant to reach Node B (which is the new active node). To preserve these packets, a tunnel is created (or an existing tunnel is used) to convey packets from Node A toward Node B. In this manner, node A behaves as a routing hop rather than an endpoint for packets destined for the redundant pair address (illustratively, the 1.1.1.1 address). In various embodiments, the tunnel comprises a Multiprotocol Label Switching (MPLS) tunnel. However, other tunneling mechanisms may also be used, such as Generic Routing Encapsulation (GRE), IP-in-IP and so on.

Upon determining that a switchover is to occur, the routes of intermediate Node C and any other intermediate nodes are updated such that traffic continues to be received at either one of nodes A and B, instead of getting black holed at an intermediate node. After the switchover completes, packets received by the old active node (Node A) are still forwarded to the new active node (Node B) via a tunnel. This may occur for a relatively short period of time as the traffic flushes out of this path (no new traffic being added to this path).

The mechanism by which a tunnel may be formed between Inter-Chassis Redundant pair nodes depends on the network topology employed, such as whether the nodes are within the same BGP Autonomous Area, the tunneling protocol support available intermediate nodes and so on.

In this example, given that the redundant pair nodes are associated with two different Autonomous Systems, external-BGP (eBGP) may be used to advertise tunnel routes from Node B to Node A.

For the eBGP session between Node A and B, route convergence time needs to be configured to a fairly low value such that tunnel advertisement is not subject to the same route convergence delay. Therefore, in various embodiments a low value is configured for this session and, since the session is between the loopback interfaces, the session will not be subjected to a “session flap” issue. Further, since the number of routes advertised with respect to the session number will be much less than the prior route, churn in routing tables will be minimized even if some session flap were to occur.

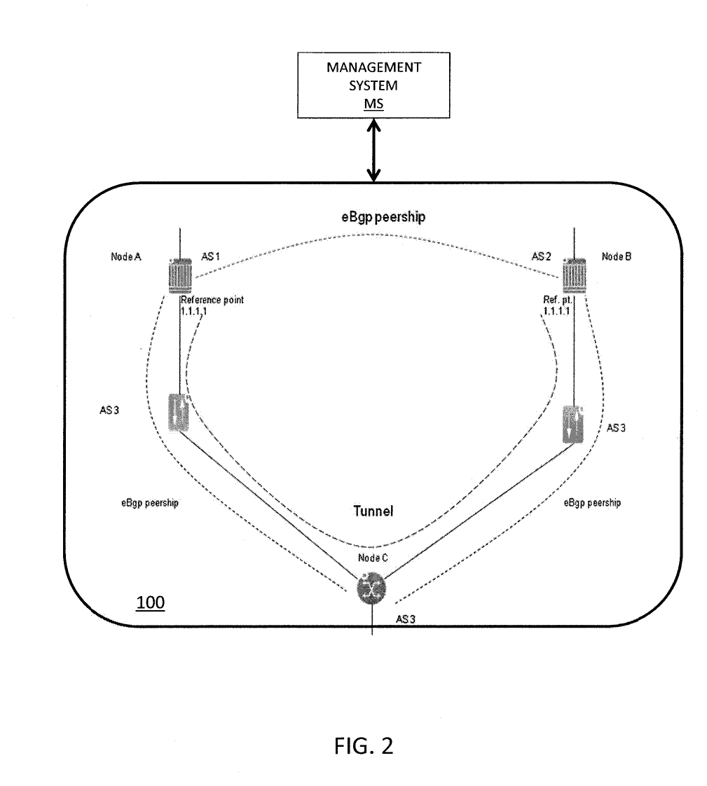

FIG. 2 depicts a high-level block diagram of the system 100 of FIG. 1, wherein a tunnel has been formed between Node A and Node B using eBGP after a forced switchover from Node A to Node B. Thus, traffic from Node A may be routed to Node B even after Node A has transitioned to nonactive status. In this manner, traffic is not black holed at Node C due to a lack of ability of Node A to route traffic. Further, traffic already on route to Node A may be successfully routed to Node B and therefore not lost.

FIGS. 1-2 also depict a management system (MS) for use in various embodiments. Specifically, in some embodiments, the various functions described herein are implemented within the context of the management system MS. In various other embodiments, the functions described herein may be implemented within the context of one or more of Node A, Node B, Node C or some other Node (not shown) .

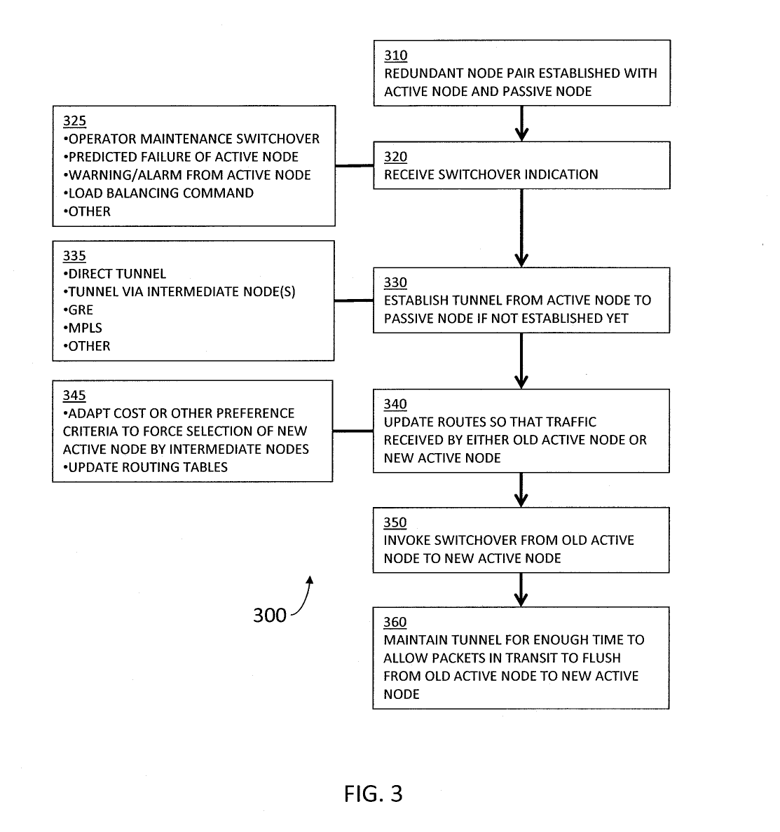

FIG. 3 depicts a flow diagram of a method according to one embodiment. Specifically, FIG. 3 depicts a method 300 for convergence-tolerant switching of traffic between redundant pairs of nodes in a network. The method 300 may be implemented by the management system MS or some other network entity configured to perform the various functions described herein.

At step 310, a redundant Node pair is established with an active node and a passive node, such as described above with respect to Node A and Node B.

At step 320, a switch of indication is received. Referring to box 325, the switchover indication may comprise an indication of an operator maintenance switchover, a predicted failure of an active node, a warning/alarm associated with an active node, a load balancing command or some other indication of imminent switchover from old active node to new active node.

At 330, the tunnel is established from the old active node to the new active node (i.e., to the old passive node) if not yet established. Referring to box 335, the tunnel may comprise a direct tunnel between the nodes, a tunnel traversing one or more intermediate nodes (such as depicted above with respect to FIG. 2), a GRE tunnel, an MPLS tunnel or some other type of tunnel.

At step 340, routes are updated such that traffic transmitted by intermediate Node is received by either the old active node or the new active node. Referring to box 345, this may be achieved by updating routing tables such as by adapting cost criteria or other preference criteria to force intermediate node routing table updates that prefer/select the new active node while allowing the old active node to forward traffic toward the new active node via the tunnel, as described above. For example, increasing the cost associated with intermediate node selection of the old active node will lead to selection of the new active node. For intermediate nodes responsive to more than just cost criteria, other preference criteria may be use, such as ranking of service flows according to customer, provider, service type or other criteria to effect thereby respective customer-based, provider-based or service type-based migration to the new active node. This staggered migration may be useful where the ability of the old active node to continue functioning may be uncertain and a preference for migrating higher quality or preferred traffic is known. Various other preference criteria may also be used.

At step 350, the switchover from old active node to new active node is invoked, such as via the management system MS or some other entity.

At step 360, the tunnel is maintained for enough time to allow packets in transit to/from the old active node to flash through the tunnel to be received by the new active node (e.g., the nominal 50+ seconds normally associated with such a switchover plus some margin). Thus, after a predetermined time period, or after a determination is made that routing packets via the tunnel is no bargain necessary, the tunnel may be torn down.

It is noted that steps 330-350 are depicted in a particular sequence. However, this sequence is not necessary within the context of the various embodiments. Specifically, the actions taken at steps 330, 340 and 350 may occur in a contemporaneous manner. For example, upon receiving a switch of indication at step 320, commands adapted to establish the tunnel (step 330) and update routes (step 340) and invoke the switchover (step 350) may be generated immediately, or after some delay, or in a staggered fashion in any order.

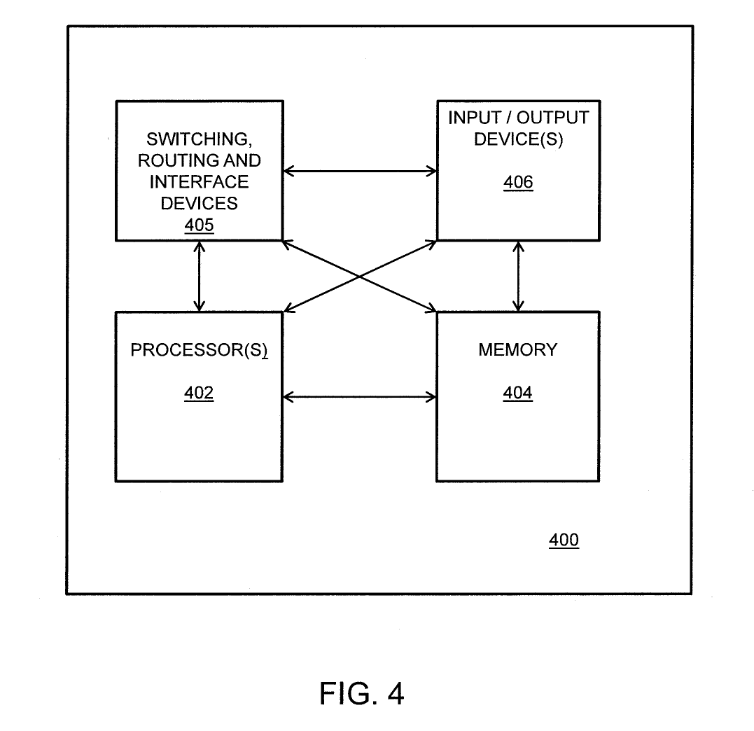

FIG. 4 depicts a high-level block diagram of a computing device, such as a processor in a telecom network element, suitable for use in performing functions described herein such as those associated with the various elements described herein with respect to the figures, such as the nodes, MS or controller portions thereof.

As depicted in FIG. 4, computing device 400 includes a processor element 403 (e.g., a central processing unit (CPU) and/or other suitable processor(s)), a memory 404 (e.g., random access memory (RAM), read only memory (ROM), and the like), cooperating module/process 405, and various input/output devices 406 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

In the case of a routing or switching device such as Node A, Node B, Node C or any other node, switching or routing device, the cooperating module process 405 implement various switching devices, routing devices, interface devices and so on as noted those skilled in the art. Thus, the computing device 400 is implemented within the context of such a routing or switching device (or within the context of one or more modules or sub-elements of such a device), further functions appropriate to that routing or switching device or also contemplated and these further functions are in communication with or otherwise associated with the processor 402, input-output devices 406 and memory 404 of the computing device 400 described herein.

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 405 can be loaded into memory 404 and executed by processor 403 to implement the functions as discussed herein. Thus, cooperating process 405 (including associated data structures) can be stored on a computer readable storage medium, e.g., RAM memory, magnetic or optical drive or diskette, and the like.

It will be appreciated that computing device 400 depicted in FIG. 4 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product comprising a non-transitory computer readable medium storing instructions for causing a processor to implement various methods and/or techniques such as described herein. Instructions for invoking the inventive methods may be stored in tangible and non-transitory computer readable medium such as fixed or removable media or memory, and/or stored within a memory within a computing device operating according to the instructions.

Various embodiments contemplate an apparatus including a processor and memory, where the processor is configured to perform some or all of the various functions described herein, as well communicate with other entities/apparatus including respective processors and memories to exchange control plane and data plane information in accordance of the various embodiments.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for reducing traffic loss during redundant pair switchover from an old active node to a new active node, comprising:
establishing a tunnel between the old active node and the new active node; and
updating routing tables to cause intermediate node preference for the new active node;
wherein packets routed toward the old active node prior to routing protocol convergence to the new active node are routed to the new active node via the established tunnel.

2. The method of claim 1, wherein said routing tables are updated by adapting preference criteria associated with one or both of the old active node and the new active node.

3. The method of claim 2, wherein said preference criteria are adapted to indicate that a path associated with the old active node is of higher cost than a path associated with the new active node.

4. The method of claim 1, wherein said routing tables are updated using Border Gateway Protocol (BGP).

5. The method of claim 1, wherein said tunnel between the old active node and the new active node traverses at least one intermediate node.

6. The method of claim 5, wherein said old active node, new active node and intermediate Node comprise BGP peer nodes.

7. The method of claim 6, wherein at least two of said BGP peer nodes are associated with different Administrative Areas (AA) and associated with a common external BGP (eBGP) session.

8. The method of claim 1, wherein said tunnel comprises a Multiprotocol Label Switching (MPLS) tunnel.

9. The method of claim 1, wherein said tunnel comprises one of a Generic Routing Encapsulation (GRE) tunnel and an IP-in-IP tunnel.

10. The method of claim 1, further comprising tearing down established tunnel after a predetermined time period.

11. An apparatus including a processor and memory, where the processor is configured to perform a method for reducing traffic loss during redundant pair switchover from an old active node to a new active node, the method comprising:
establishing a tunnel between the old active node and the new active node; and
updating routing tables to cause intermediate Node preference for the new active node;
wherein packets routed toward the old active node prior to routing protocol convergence to the new active node are routed to the new active node via the established tunnel.

12. The apparatus of claim 11, wherein said routing tables are updated by adapting preference criteria associated with one or both of the old active node and the new active node.

13. The apparatus of claim 12, wherein said preference criteria are adapted to indicate that a path associated with the old active node is of higher cost than a path associated with the new active node.

14. The apparatus of claim 11, wherein said routing tables are updated using Border Gateway Protocol (BGP).

15. The apparatus of claim 11, wherein said tunnel between the old active node and the new active node traverses at least one intermediate node.

16. The apparatus of claim 15, wherein said old active node, new active node and intermediate Node comprise BGP peer nodes.

17. The apparatus of claim 16, wherein at least two of said BGP peer nodes are associated with different Administrative Areas (AA) and associated with a common external BGP (eBGP) session.

18. The apparatus of claim 11, wherein said tunnel comprises one of a Multiprotocol Label Switching (MPLS) tunnel, a Generic Routing Encapsulation (GRE) tunnel and an IP-in-IP tunnel.

19. A tangible and non-transient computer readable storage medium storing instructions which, when executed by a computer, adapt the operation of the computer to perform a method for reducing traffic loss during redundant pair switchover from an old active node to a new active node, the method comprising:
establishing a tunnel between the old active node and the new active node; and
updating routing tables to cause intermediate Node preference for the new active node;
wherein packets routed toward the old active node prior to routing protocol convergence to the new active node are routed to the new active node via the established tunnel.

20. A computer program product comprising a non-transitory computer readable medium storing instructions for causing a processor to implement a method for reducing traffic loss during redundant pair switchover from an old active node to a new active node, the method comprising:
establishing a tunnel between the old active node and the new active node; and
updating routing tables to cause intermediate Node preference for the new active node;
wherein packets routed toward the old active node prior to routing protocol convergence to the new active node are routed to the new active node via the established tunnel.
